(19) United States
(12) Patent Application Publication
(10) Pub. No.: US 2024/0174021 A1
(43) Pub. Date: May 30, 2024

(54) Attachable Paintbrush Holder Device

(71) Applicant: Ricardo Jesus Arsate, San Antonio, TX (US)

(72) Inventor: Ricardo Jesus Arsate, San Antonio, TX (US)

(21) Appl. No.: 18/470,086

(22) Filed: Sep. 19, 2023

Related U.S. Application Data
(60) Provisional application No. 63/428,447, filed on Nov. 29, 2022.

(51) Int. Cl. B44D 3/12

(52) U.S. Cl. CPC B44D 3/123

(57) ABSTRACT

An attachable paintbrush holder device is provided. The device is comprised of a back plate and at least one side wall that forms an interior space with the back plate. The device is intended to allow a user to store a paintbrush on their person via their belt by attaching a belt through the back plate via two openings in the back plate or a fastener. Then, a user can place a paintbrush into the interior space when not in use.

### CROSS-REFERENCE TO RELATED APPLICATION

The present application claims priority to, and the benefit of, U.S. Provisional Application No. 63/428,447, which was filed on Nov. 29, 2022, and is incorporated herein by reference in its entirety.

### FIELD OF THE INVENTION

The present invention relates generally to the field of paintbrushes. More specifically, the present invention relates to an attachable paintbrush holder device. The device can be attached to a user's belt or another object via a fastener or two openings in a back plate of the device. As a result, the device stores a paintbrush hands-free on a user's person. Accordingly, the present disclosure makes specific reference thereto. Nonetheless, it is to be appreciated that aspects of the present invention are also equally applicable to other like applications, devices, and methods of manufacture.

### BACKGROUND

Painters move around many areas while painting. In some circumstances, a painter may need to climb a ladder to access different areas to paint. However, trying to hold a paintbrush in one hand while attempting to climb a ladder with the other can be difficult and dangerous. In addition, a painter may need to set a brush down while painting for several reasons. However, setting a paintbrush down may cause the brush to become dirty. In addition, leaving a paintbrush with wet paint on a surface can lead to paint running off the brush and staining the surface. Furthermore, paintbrushes can be easily misplaced if not kept in a specific area.

Therefore, there exists a long-felt need in the art for a paintbrush-holding device. More specifically, there exists a long-felt need in the art for an attachable paintbrush holder device that allows a user to store a paintbrush on their person while moving. There also exists a long-felt need in the art for an attachable paintbrush holder device that prevents a paintbrush from becoming dirty when not in use. In addition, there exists a long-felt need in the art for an attachable paintbrush holder device that prevents a paintbrush from spilling paint onto a surface when not in use. Furthermore, there exists a long-felt need in the art for an attachable paintbrush holder device that prevents a paintbrush from being misplaced.

The subject matter disclosed and claimed herein, in one embodiment thereof, comprises an attachable paintbrush holder device. The device is primarily comprised of a back plate and at least one side wall that forms an interior space with the back plate. The device is intended to allow a user to store a paintbrush on their person via their belt by attaching a belt through the back plate via two openings in the back plate or a fastener. Then, a user can place a paintbrush into the interior space when not in use. In one embodiment, the interior space receives at least one removable liner that catches paint from the paintbrush and can then be discarded after use.

In this manner, the attachable paintbrush holder device of the present invention accomplishes all the foregoing objectives and provides a device for holding a paintbrush. More specifically, the device allows a user to store a paintbrush on their person while moving, thus freeing both of their hands. The device also prevents a paintbrush from becoming dirty when not in use and from spilling paint onto a surface when not in use. Furthermore, the device prevents a paintbrush from being misplaced as the paintbrush is kept on the user's person.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an attachable paintbrush holder device primarily comprised of a back plate and at least one side wall that forms an interior space with the back plate. The device is intended to allow a user to store a paintbrush on their person via their belt. The back plate is preferably rectangular in shape. At least one side wall forms an interior space with the back plate that houses the bristles of at least one paintbrush.

In one embodiment, the back plate has two openings that allow a belt to be fed through the openings to attach the device to the belt. As a result, the device is secured to the person of the user to allow the user to easily store a paintbrush within the device while remaining within reach. In another embodiment, the rear surface of the back plate may be comprised of at least one fastener that allows the device to be clipped to a belt or attached to a ladder or other object.

The interior space receives a paintbrush that may have bristles covered in wet paint. To prevent the wet paint from transferring from the bristles to the interior space, the interior space may receive at least one removable liner. The liner is preferably a plastic, bag-like liner that can be removed from the interior space once a user is done storing the brush within the interior space.

The present invention is also comprised of a method of using the device. First, a device is provided comprised of a back plate with two openings and/or at least one fastener, and at least one side wall that forms an interior space with the back plate. Next, the device can be secured to a belt (or another object) by feeding the belt through both openings or attaching the fastener to the belt (or object such as, but not limited to, a ladder). Then, a paintbrush can be inserted into the interior space when not in use, while remaining nearby and accessible to a user.

Accordingly, the attachable paintbrush holder device of the present invention is particularly advantageous as it provides a device for holding a paintbrush. More specifically, the device allows a user to store a paintbrush on their person while moving, thus freeing both of their hands. The device also prevents a paintbrush from becoming dirty when not in use and from spilling paint onto a surface when not in use. Furthermore, the device prevents a paintbrush from being misplaced as the paintbrush is kept on the user's person. In this manner, the attachable paintbrush holder device overcomes the limitations of existing methods of using and storing paintbrushes known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an attachable paintbrush holder device of the present invention while a paintbrush is stored within the device in accordance with the disclosed architecture;

FIG. 2 illustrates a perspective view of one potential embodiment of an attachable paintbrush holder device of the present invention while attached to a belt in accordance with the disclosed architecture;

FIG. 3 illustrates a perspective view of one potential embodiment of an attachable paintbrush holder device of the present invention while attached to a pocket in accordance with the disclosed architecture; and

FIG. 4 illustrates a flowchart of a method of using one potential embodiment of an attachable paintbrush holder device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a paintbrush-holding device. More specifically, there exists a long-felt need in the art for an attachable paintbrush holder device that allows a user to store a paintbrush on their person while moving. There also exists a long-felt need in the art for an attachable paintbrush holder device that prevents a paintbrush from becoming dirty when not in use. In addition, there exists a long-felt need in the art for an attachable paintbrush holder device that prevents a paintbrush from spilling paint onto a surface when not in use. Furthermore, there exists a long-felt need in the art for an attachable paintbrush holder device that prevents a paintbrush from being misplaced.

The present invention, in one exemplary embodiment, is comprised of an attachable paintbrush holder device primarily comprised of a back plate and at least one side wall that forms an interior space with the back plate. The device is intended to allow a user to store a paintbrush on their person via their belt. The back plate is preferably rectangular in shape. At least one side wall forms an interior space with the back plate that houses the bristles of at least one paintbrush.

In one embodiment, the back plate has two openings. The openings allow a belt to be fed through the openings to attach the device to the belt. As a result, the device is secured to the person of the user to allow the user to easily store a paintbrush within the device while remaining within reach. In another embodiment, the rear surface of the back plate may be comprised of at least one fastener that allows the device to be clipped to a belt or attached to a ladder or other object.

The interior space receives a paintbrush that may have bristles covered in wet paint. To prevent the wet paint from transferring from the bristles to the interior space, the interior space may receive at least one removable liner. The liner is preferably a plastic, bag-like liner that can be removed from the interior space once a user is done storing the brush within the interior space.

The present invention is also comprised of a method of using the device. First, a device is provided comprised of a back plate with two openings and/or at least one fastener, and at least one side wall that forms an interior space with the back plate. Next, the device can be secured to a belt (or another object) by feeding the belt through both openings or attaching the fastener to the belt (or object such as, but not limited to, a ladder). Then, a paintbrush can be inserted into the interior space when not in use, while remaining nearby and accessible to a user.

Accordingly, the attachable paintbrush holder device of the present invention is particularly advantageous as it provides a device for holding a paintbrush. More specifically, the device allows a user to store a paintbrush on their person while moving, thus freeing both their hands. The device also prevents a paintbrush from becoming dirty when not in use and from spilling paint onto a surface when not in use. Furthermore, the device prevents a paintbrush from being misplaced as the paintbrush is kept on the user's person. In this manner, the attachable paintbrush holder device overcomes the limitations of existing methods of using and storing paintbrushes known in the art.

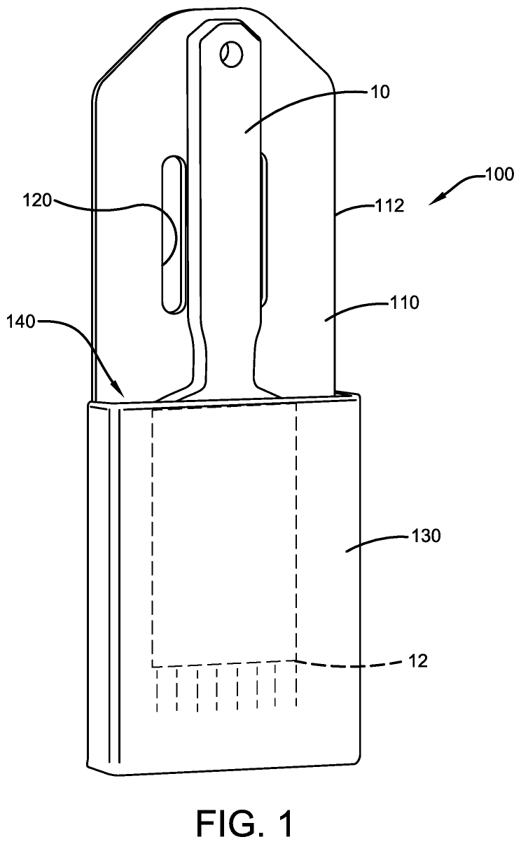

Referring initially to the drawings, FIG. 1 illustrates a perspective view of one potential embodiment of an attachable paintbrush holder device 100 of the present invention while a paintbrush 10 is stored within the device in accordance with the disclosed architecture. The device 100 is primarily comprised of a back plate 110 and at least one side wall 130 that forms an interior space 140 with the back plate 110. The device is intended to allow a user to store a paintbrush 10 on their person via their belt 20.

The device 100 is preferably made from a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The device 100 may additionally or alternatively be made from a durable metal material such as, but not limited to, aluminum.

The back plate 110 is preferably rectangular in shape, but may be any shape known in the art. The edges 112 of the back plate 110 are preferably rounded such that the back plate 110 does not jab into the body of a user while attached to a user's belt 20. At least one side wall 130 forms an interior space with the back plate 110. The interior space 140 houses the bristles 12 of at least one paintbrush 10.

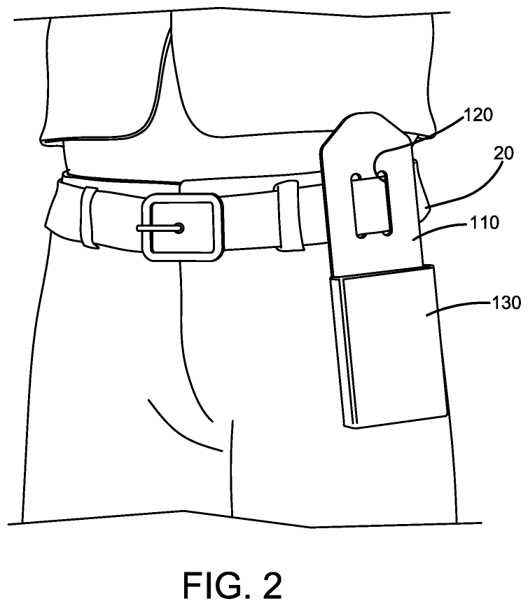

In one embodiment, the back plate 110 is comprised of at least one opening 120. In the preferred embodiment, the back plate 110 has two openings 120 that allow a belt 20 to be fed through the openings 120 to attach the device 100 to the belt 20, as seen in FIG. 2. As a result, the device 100 is secured to the person of the user to allow the user to easily store a paintbrush 10 within the device while remaining within reach.

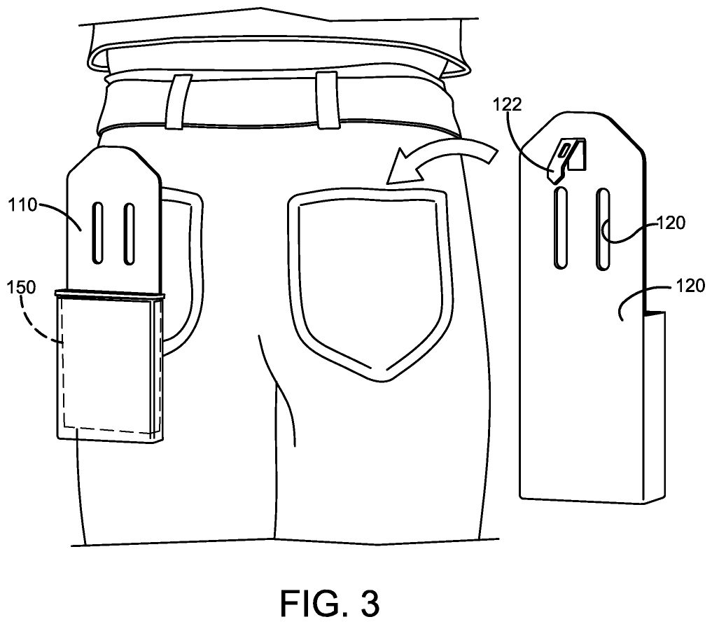

In another embodiment, the rear surface 120 of the back plate 110 may be comprised of at least one fastener 122. In one embodiment the fastener 122 is a locking clip that allows the device 100 to be removably clipped to a belt 20, pocket, or other clothing/area, as seen in FIG. 3. In another embodiment, the fastener 122 is a magnet that allows the device 100 to be secured to a metal ladder. In a further embodiment, the back plate 110 itself may be made from a magnetic material to allow the device 100 to be secured to a metal ladder.

The interior space 140 receives a paintbrush 10 that may have bristles 12 covered in wet paint. To prevent the wet paint from transferring from the bristles 12 to the interior space 140, the interior space 140 may receive at least one removable liner 150. The liner 150 is preferably a plastic, bag-like liner that can be removed from the interior space 140 once a user is done storing the brush 10 within the interior space 140. In addition, a user can change liners 150 when changing the colors of paint used with the brush 10 to prevent the previous color of paint on the brush from transferring and mixing with the new color on the brush 10. In another embodiment, the device 100 does not have a liner 150 and can simply be washed between uses.

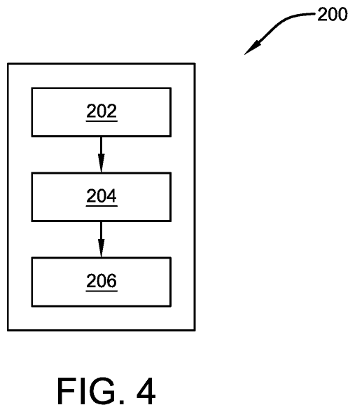

The present invention is also comprised of a method of using 200 the device 100, as seen in FIG. 4. First, a device 100 is provided comprised of a back plate 110 with two openings 120 and/or at least one fastener 122, and at least one side wall 130 that forms an interior space 140 with the back plate 110 [Step 202]. Next, the device 100 can be secured to a belt 20 (or another object) by feeding the belt 20 through both openings 120 or attaching the fastener 122 to the belt 20 (or object such as, but not limited to, a metal object such as a ladder) [Step 204]. Then, a paintbrush 10 can be inserted into the interior space 140 when not in use, while remaining nearby and accessible to a user [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “attachable paintbrush holder device” and “device” are interchangeable and refer to the attachable paintbrush holder device 100 of the present invention.

Notwithstanding the foregoing, the attachable paintbrush holder device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the attachable paintbrush holder device 100 as shown in the FIGS. are for illustrative purposes only, and that many other sizes and shapes of the attachable paintbrush holder device 100 are well within the scope of the present disclosure. Although the dimensions of the attachable paintbrush holder device 100 are important design parameters for user convenience, the attachable paintbrush holder device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An attachable paintbrush holder device comprising:
a back plate having a first opening and a second opening; and
a side wall attached to the back plate, wherein the side wall forms an interior space with the back plate.

2. The attachable paintbrush holder device of claim 1, wherein the back plate is comprised of a round edge.

3. The attachable paintbrush holder device of claim 1, wherein the back plate is comprised of a metal material.

4. The attachable paintbrush holder device of claim 1 further comprised of a liner.

5. The attachable paintbrush holder device of claim 4, wherein the liner is comprised of a plastic material.

6. An attachable paintbrush holder device comprising:
a back plate having a rear surface;
a fastener; and
a side wall attached to the back plate, wherein the side wall forms an interior space with the back plate.

7. The attachable paintbrush holder device of claim 6, wherein the back plate is comprised of a round edge.

8. The attachable paintbrush holder device of claim 6, wherein the fastener is comprised of a clip.

9. The attachable paintbrush holder device of claim 6, wherein the fastener is comprised of a magnet.

10. The attachable paintbrush holder device of claim 6 further comprised of a liner.

11. The attachable paintbrush holder device of claim 10, wherein the liner is comprised of a plastic material.

12. The attachable paintbrush holder device of claim 6, wherein the back plate is comprised of a plastic material.

13. The attachable paintbrush holder device of claim 6, wherein the back plate is comprised of a magnetic material.

14. A method of using an attachable paintbrush holder device, the method comprising the following steps:
providing an attachable paintbrush holder device comprised of a back plate with two openings, and at least one side wall that forms an interior space with the back plate;
securing the attachable paintbrush holder device to a belt by feeding the belt through both of the two openings of the back plate; and
inserting a paintbrush into the interior space.

15. The method of claim 14 further comprised of a step of placing a removable liner into the interior space.

16. The method of claim 14, wherein a rear surface of the back plate is comprised of a fastener.

17. The method of claim 14 further comprised of a step of attaching the fastener to a belt.

18. The method of claim 14 further comprised of a step of attaching the fastener to an object.

19. The method of claim 14, wherein the backplate is comprised of a magnetic material.

20. The method of claim 19 further comprised of a step of attaching the backplate to a metal object.
